(19) United States
(12) Patent Application Publication
(10) Pub. No.: US 2020/0004454 A1
(43) Pub. Date: Jan. 2, 2020

(54) TECHNIQUE FOR MEMORY MANAGEMENT ON SERVICE ORIENTED ARCHITECTURE

(71) Applicant: TMAXSOFT CO., LTD., Gyeonggi-do (KR)

(72) Inventor: Seong Hwan Jang, Gyeonggi-do (KR)

(21) Appl. No.: 16/021,953

(22) Filed: Jun. 28, 2018

(30) Foreign Application Priority Data
Jun. 27, 2018 (KR) 10-2018-0073851

(51) Int. Cl. G06F 3/06

(52) U.S. Cl. CPC G06F 3/0653; H04L 67/16; G06F 3/067; G06F 3/0604

(57) ABSTRACT

Disclosed is a computer program stored in a computer-readable storage medium according to an exemplary embodiment of the present disclosure. The computer program executes the following methods for controlling a memory on a service-oriented architecture when the computer program is executed by one or more processors of a computing device and the method may include: creating, by the processor, a memory basket for measuring a first memory usage of a service as receiving a call of the service; measuring, by the processor, a second memory usage to be used by a first service logic when the first service logic is performed; updating, by the processor, the memory basket based on the second memory usage; and determining, by the processor, whether the first memory usage exceeds a predetermined tolerance based on the updated memory basket.

### CROSS-REFERENCE TO RELATED APPLICATIONS

This application claims priority to and the benefit of Korean Patent Application No. 10-2018-0073851 filed in the Korean Intellectual Property Office on Jun. 27, 2018, the entire contents of which are incorporated herein by reference.

### TECHNICAL FIELD

The present disclosure relates to memory management, and more particularly, to control of a memory on a service-oriented architecture (SOA).

### BACKGROUND ART

Service-oriented architecture (SOA) is a set of services that execute business processes by communication over a network. The communication in the service-oriented architecture can involve two or more services that involve simple data transfer or coordinate any activity. The services are loosely coupled (meaning that one application does not need to know in detail structures and operations of other applications to communicate with other applications), have a well-defined platform-independent interface, and are reusable. In general, the service-oriented architecture is built by a system in which one or more businesses are tied together with fragmented data and business processes.

Service-oriented architecture services are functions that can be invoked through an independently implemented interface. A service provider is an entity that provides services to other entities and a service requester is an entity that uses the service. In the service-oriented architecture, the service provider provides a service interface through which the service requester can retrieve and request a required service.

There is a problem that when an available memory is insufficient while processing the service on the service-oriented architecture, a system is down. Thus, there is a need in the art for a method for controlling the memory during service processing on the service-oriented architecture.

### SUMMARY OF THE INVENTION

The present disclosure has been made in an effort to provide a method for controlling a memory on a service-oriented architecture (SOA).

However, technical objects of the present disclosure are not restricted to the technical objects mentioned as above. Unmentioned technical objects will become more apparent to those skilled in the art from the following description.

An exemplary embodiment of the present disclosure provides a computer program stored in a computer-readable storage medium. The computer program executes the following methods for controlling a memory on a service-oriented architecture when the computer program is executed by one or more processors of a computing device and the method may include: creating, by the processor, a memory basket for measuring a first memory usage of a service as receiving a call of the service; measuring, by the processor, a second memory usage to be used by a first service logic when the first service logic is performed; updating, by the processor, the memory basket based on the second memory usage; and determining, by the processor, whether the first memory usage exceeds a predetermined tolerance based on the updated memory basket.

The method may further include terminating, by the processor, the service by the processor if the first memory usage exceeds the predetermined tolerance.

The method may further include creating the memory basket in a request context allocated to the service.

The updating may include accumulating the measured second memory usage in the memory basket.

The first service logic may be a logic applied with an aspect in which execution of the updating step is a cross-cutting concern by using an aspect-oriented programming (AOP) module included in the processor.

A time point when the aspect is applied may be a time point when a source code of the first service logic is complied.

A time point when the aspect is applied may be a time point when the source code of the first service logic is executed.

The first service logic may be a logic that sets data to a data object.

The method may further include clearing, by the processor, the memory basket when the service is terminated.

Another exemplary embodiment of the present disclosure provides a method for controlling a memory on a service-oriented architecture (SOA) performed by one or more processors. The method may include: creating, by the processor, a memory basket for measuring a first memory usage of a service as receiving a call of the service; measuring, by the processor, a second memory usage to be used by a first service logic when the first service logic is performed; updating, by the processor, the memory basket based on the second memory usage; and determining, by the processor, whether the first memory usage exceeds a predetermined tolerance based on the updated memory basket.

Yet another exemplary embodiment of the present disclosure provides a computing device. The computing device may include: one or more processors; and a memory storing commands executable in the one or more processors, in which the one or more processors may create a memory basket with respect to a call of a service, measure a memory usage by a first service logic module when the first service logic is performed, update the memory basket based on the measured memory usage, and determine whether a predetermined memory tolerance for the service is exceeded based on the memory basket.

Technical solving means which can be obtained in the present disclosure are not limited to the aforementioned solving means and other unmentioned solving means will be clearly understood by those skilled in the art from the following description.

According to an exemplary embodiment of the present disclosure, a method for controlling a memory on a service-oriented architecture can be provided and down of a system can be prevented.

### BRIEF DESCRIPTION OF THE DRAWINGS

Various aspects are now described with reference to the drawings and like reference numerals are generally used to designate like elements. In the following exemplary embodiments, for a purpose of description, multiple specific detailed matters are presented to provide general understanding of one or more aspects. However, it will be apparent that the aspect(s) can be executed without the detailed matters. In other examples, known structures and apparatuses are illustrated in a block diagram form in order to facilitate description of the one or more aspects.

FIG. 1 illustrates a data processing system capable of implementing an exemplary embodiment of the present disclosure on a service-oriented architecture.

FIG. 2 is a diagram for describing a service-oriented architecture according to an exemplary embodiment of the present disclosure.

FIG. 3 illustrates a computing device according to an exemplary embodiment of the present disclosure.

FIG. 4 is a flowchart for describing a method for controlling a memory on a service-oriented architecture according to an exemplary embodiment of the present disclosure.

FIG. 5 is a flowchart for describing a method for controlling a memory on a service-oriented architecture according to an exemplary embodiment of the present disclosure.

FIG. 6 is a flowchart for describing an operation related to a memory basket according to an exemplary embodiment of the present disclosure.

FIG. 7 is a diagram for describing an AOP module according to an exemplary embodiment of the present disclosure.

FIG. 8 is a diagram for describing a means for controlling a memory on a service-oriented architecture according to an exemplary embodiment of the present disclosure.

FIG. 9 is a diagram for describing a module for controlling a memory on a service-oriented architecture according to an exemplary embodiment of the present disclosure.

FIG. 10 is a diagram for describing a logic for controlling a memory on a service-oriented architecture according to an exemplary embodiment of the present disclosure.

FIG. 11 is a diagram for describing a circuit for controlling a memory on a service-oriented architecture according to an exemplary embodiment of the present disclosure.

FIG. 12 illustrates a simple and general schematic view of an exemplary computing environment in which exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or the execution thread. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, and the case where X uses both A and B. Further, it should be understood that the term “and/or” used in the specification designates and includes all available combinations of one or more items among enumerated related items.

It should be appreciated that the term “comprise” and/or “comprising” means that presence or inclusion of corresponding features and/or components. However, it should be appreciated that the term “comprises” and/or “comprising” means that presence or inclusion of one or more other features, components, and/or a group thereof is not excluded. Further, when not separately specified or not clear in terms of the context that a singular form is indicated, it should be construed that the singular form generally means “one or more” in the present specification and the claims.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, structures, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

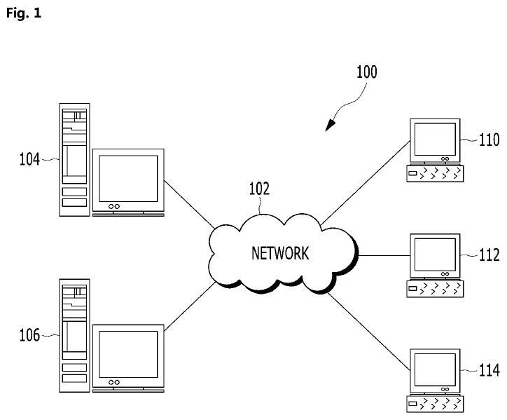

FIG. 1 illustrates a data processing system 100 in which the exemplary embodiment of the present disclosure may be implemented. A network data processing system 100 is a computer network which may implement the exemplary embodiment of the present disclosure on a service-oriented architecture. The network data processing system 100 includes a network 102 for communication between various devices and computers that are connected together within the network data processing system 100. A network 102 may include connections such as a wired or wireless communication link or an optical fiber cable.

In the illustrated example, a server 104 and a server 106 may be connected to the network 102. Further, terminals 110, 112, and 114 may be connected to the network 102. The terminals 110, 112, and 114 may be, for example, a personal computer or a network computer. In the illustrated example, the server 104 may provide information such as a boot file, an operating system, and applications for the terminals 110, 112, and 114. In such an example, the terminals 110, 112, and 114 may be clients for the server 104. The network data processing system 100 may include additional servers, terminals, and other devices not illustrated.

In the network data processing system 100, a computer program may be stored on any computer-readable storage medium and downloaded and used in a computing device or other device. For example, a program code may be stored in a computer-readable storage medium of the server 104, downloaded to the terminal 110 via the network 102, and used by the terminal 110.

In the illustrated example, the network data processing system 100 may be the wired/wireless Internet representing a global set of networks and gateways with which the network 102 communicates by using a protocol of a transmission control protocol/Internet protocol (TCP/IP) chute. As the wireless Internet technology, wireless LAN (WLAN) (Wi-Fi), wireless broadband (Wibro), world interoperability for microwave access (Wimax), high speed downlink packet access (HSDPA), or the like, may be used. As wired Internet technology, a digital subscriber line (XDSL), fibers to the home (FTTH), power line communication (PLC), or the like may be used. Of course, the network data processing system 100 may also be implemented as a number of different types of networks such as an intranet, a local area network (LAN), or a wide area network (WAN). As short-range communication technology, Bluetooth, radio frequency identification (RFID), infrared data association (IrDA), ultra wideband (UWB), ZigBee, or the like may be used. FIG. 1 is merely an example and does not limit other embodiments.

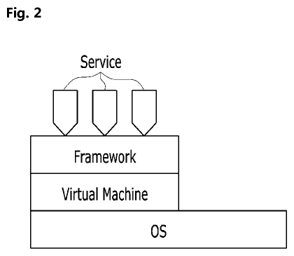

FIG. 2 is a diagram for describing a service-oriented architecture according to an exemplary embodiment of the present disclosure.

The service-oriented architecture according to the present disclosure may be implemented by the network data processing system 100 described above. A hierarchical structure illustrated in FIG. 2 is merely an example and does not limit other examples of the present disclosure. Referring to FIG. 2, an application for performing services on the service-oriented architecture may operate on a framework layer. In the present specification, the framework and the service-oriented architecture may be used in the same sense. In an exemplary embodiment, such a framework may operate on a virtual machine layer, while in another exemplary embodiment, the framework may operate directly on an operating system (OS) layer without going through the virtual machine layer. Various types of virtual machines may be used and for example, the virtual machine may be Java VM.

In an exemplary embodiment, when the framework operates on the virtual machine layer, the memory usable by the framework may be limited by the virtual machine. In another exemplary embodiment, when the framework operates directly on the OS layer without going through the virtual machine layer, the memory usable by the framework may be limited by the OS. The framework may allocate the memory required for service processing. In the event that the memory usable by the framework is insufficient due to memory allocation, the system may go down as described above. By limiting a maximum memory usage of a service invoked on the service-oriented architecture, a method for controlling the memory of the present disclosure may prevent the system from going down due to a lack of memory needed during the service processing.

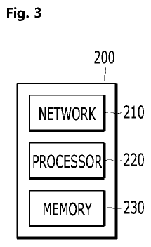

FIG. 3 illustrates a computing device 200 according to an exemplary embodiment of the present disclosure.

Referring to FIG. 3, the computing device 200 according to an exemplary embodiment of the present disclosure is illustrated. In an exemplary embodiment of the present disclosure, the computing device 200 may include a network unit 210, a processor 220, and a memory 230. Of course, in an exemplary embodiment of the present disclosure, the computing device 200 may include other components for performing a computing environment of the computing device 200. The computing device 200 may be a terminal or server. For example, the computing device 200 may be the servers 104 and 106 or the terminals 110, 112, and 114 of FIG. 1 and computer programs or commands implementing a predetermined process may be executed by the computing device 200 for an exemplary embodiment. The computing device 200 may be all arbitrary types of devices. The computing device 200 as a digital device may be a digital device with a calculation capability, which has a processor installed therein and a memory, such as a laptop computer, a notebook computer, a desktop computer, a web pad, or a mobile phone. The computing device 200 may be a web server processing a service.

The network unit 210 may include a transmission unit and a reception unit. The network unit 210 may include a wired/wireless Internet module for accessing a network 102. Further, the network unit 210 may be positioned at a comparatively short distance from the computing device including a short range communication module and transmit and receive data to and from an electronic apparatus including the short range communication module. In an exemplary embodiment of the present disclosure, the network unit 210 may sense a connection state of the network and transmission and reception speeds of the network. Data received through the network unit 210 may be stored through the memory 230 or transmitted to other electronic apparatuses positioned in a short range through the short-range communication module.

The network unit 210 may receive the call of the service by the client from the external computing device and transfer the received call to the processor. The processor 220 that receives the service call may process the called service. The network unit 210 may transmit and receive data for processing the service and data for controlling a memory while processing the service to and from other computing devices, servers, and the like. In addition, the network unit 210 may enable communication among a plurality of computing devices so that called service processing is distributively performed in each of the plurality of computing devices.

The processor 220 may be constituted by one or more cores and may include processors for data analysis and service processing, which include a thread, a central processing unit (CPU) of the computing device, a general purpose graphics processing unit (GPGPU), a tensor processing unit (TPU), and the like. Further, the computer program executed in the computing device according to an exemplary embodiment of the present disclosure may be a CPU, GPGPU, or TPU executable program. The processor 220 reads the computer program stored in the memory 230 to process the called service. Further, the processor 220 may read a computer program stored in the memory 230 to perform the memory controlling method according to an exemplary embodiment of the present disclosure.

The service may mean one operation to be processed by the processor on the service-oriented architecture. The service logic may be a component including some of steps for processing the service. The service may include one or more service logics. When processing one or more service logics included in the service is completed, processing the service may be completed. The thread may be one work unit in the processing of the service. The thread may be a unit of a flow executed in a process. The thread may contain information needed to perform the processing for the service. The service may include a task which the client intends to process by using the computing device 200. For example, the service may be an account transfer task for customer A, which the client (that is, a banker terminal, etc.) of the computing device 200, which constitutes the server of a bank, wishes to process using the computing device 200. For example, other services may be the account transfer task, an account inquiry task, etc. for customer B, which the client (that is, the banker terminal, etc.) of the computing device 200, which constitutes the server of the bank, wishes to process using the computing device 200. The disclosure of the service described above is just an example and the present disclosure is not limited thereto.

In an exemplary embodiment of the present disclosure, the computing device 200 may distribute and process the service processing by using at least one of the CPU, the GPGPU, and the TPU. Further, in an exemplary embodiment of the present disclosure, the computing device 200 may distribute and process the service processing together with other computing devices.

In an exemplary embodiment of the present disclosure, the processor 220 may generate a memory basket for measuring a first memory usage of the service as receiving the call of the service.

The processor 220 may measure the first memory usage. The first memory usage may refer to the memory usage of the service on the memory 230 of the computing device 200. For example, the first memory usage may refer to the memory usage while the service logic included in the called service is processed.

The processor 220 may generate the memory basket for measuring the first memory usage when the call of the service is received. The memory basket may store information on the first memory usage while the service is performed. For example, the memory basket may store information about an increase or decrease in memory usage by the service logic performed so far. The memory basket is updated while the called service is processed to be used to measure the first memory usage.

The memory basket may be created in the memory which may be used by the framework in the memory 230 of the computing device 200. For example, the memory basket may be created in a request context that is allocated to the service. The request context may refer to a memory of the framework that is uniquely accessible only by a thread for processing the called service. The request context is activated while the thread processes the service and the memory used by the request context may be returned if the processing of the service is completed. Accordingly, the memory control method of the present disclosure may prevent the memory basket from being unnecessarily resident on the memory 230 after the processing of the service is completed.

According to an exemplary embodiment of the present disclosure, when the processor 220 performs a first service logic, the processor 220 may measure a second memory usage to be used by the first service logic.

As described above, the service may include one or more service logics. For example, the service may include the first service logic. The first service logic may be a logic that requires the allocation of additional memory 230 among the service logics included in the called service. In this case, the second memory usage may refer to a memory usage additionally allocated by the first service logic. Specifically, for example, the first service logic may be a logic that sets data to a data object. Here, the data object may refer to a space that is allocated to a storage space (e.g., memory) to have a value or referenced by an identifier. The data object may be a variable, a data structure, a function, or a method. The data object may be implemented by inheriting a common class from any of various frameworks. In other words, the second memory usage may be a memory usage allocated according to the type of data object or set data when data is set onto the data object. By measuring the second memory usage only when additional memory allocation is required, the memory control method of the present disclosure may prevent unnecessary resource wastage.

Description of concrete contents for the memory allocation is specifically discussed in U.S. Pat. No. 7,409,517, filed Oct. 1, 2001, which is hereby incorporated by reference in its entirety.

According to an exemplary embodiment of the present disclosure, the processor 220 may update the memory basket based on the second memory usage. As described above, the processor 220 may update the memory basket in order to measure the first memory usage. The processor 220 may update the memory basket by using various methods. For example, the processor 220 may update the memory basket by accumulating the measured second memory usage in the memory basket. Specifically, the processor 220 may update the memory basket by adding the first memory usage being used by already performed service logics and the measured second memory usage. Here, the first memory usage in use by the already performed service logics may be obtained from the previously updated memory basket. However, the present disclosure is not limited thereto and the processor 220 may update the memory basket by various methods in order to measure the first memory usage.

According to an exemplary embodiment of the present disclosure, a first service logic may be a logic applied with an aspect in which execution of the updating step is a cross-cutting concern by using an aspect-oriented programming module included in the processor. Specifically, on the service-oriented architecture, the updating step may be implemented by aspect-oriented programming (AOP) as the cross-cutting concern. The aspect-oriented programming may be a development paradigm that separates secondary or auxiliary functions from a business logic that directly implements the service or task which the application intends to provide. In the aspect-oriented programming, the business logic may be referred to as a primary concern and separate secondary or auxiliary functions may be referred to as the cross-cutting concern. For example, if the service is an account transfer from A to B, the primary concern of the service logic may be an individual operation for the account transfer and the cross-cutting concern of the service logic may be logging, security, etc. which is an auxiliary function. The AOP module may enhance system scalability, compatibility, and flexibility by implementing the secondary or auxiliary function that may be used in common for multiple business logics as the cross-cutting concern. The AOP module for the aspect-oriented programming may be implemented by AspectJ, AspectC/C++, SpringAOP, and the like depending on a system implementation language or environment, but is not limited thereto.

In an exemplary embodiment of the present disclosure, the execution of the updating step may be implemented as an independent module, called an aspect, as the cross-cutting concern and the processor may apply the aspect to the first service logic using the AOP module. In other words, a source code for implementing the updating step, which is the cross-cutting concern, may be coded on the source code of the first service logic, which is the primary concern. The updating step is implemented by the aspect-oriented programming (AOP), so that a code for an additional operation (that is, an operation of performing the update step) may be added while keeping the existing source code unmodified.

A time point at which the above-described aspect is applied may be a time point at which the source code of the first service logic is compiled. In this case, the operation for applying the aspect may be prevented from being repeated each time the source code of the first service logic is executed. However, the present disclosure is not limited thereto and the time point at which the above-described aspect is applied may be a time point at which the source code of the first service logic is executed.

According to an exemplary embodiment of the present disclosure, the processor 220 may determine whether the first memory usage exceeds a predetermined tolerance based on the updated memory basket. For example, the processor 220 may determine whether the first memory usage exceeds the predetermined tolerance by comparing the information about the first memory usage stored in the updated memory basket with a predetermined tolerance.

Here, the predetermined tolerance may be preset by the service provider or may be set by the service requester. In addition, the processor 220 may determine the predetermined tolerance based on the amount of memory usable by the service. For example, the processor 220 may determine a predetermined percentage of the remaining memory usable by the framework as the predetermined tolerance. Specifically, for example, if the remaining memory is 70% of a total capacity, the processor 220 may determine 50% (i.e., 35% of the total capacity) of 70% of the total capacity as the predetermined tolerance. The above-mentioned percentage is merely an example and does not intend to limit other exemplary embodiments.

As another example, the processor 220 may determine the predetermined tolerance based on a prediction value of the first memory usage to be used during processing of the called service. For example, the processor 220 may determine whether the called service is a service that is previously processed. When the called service is the previously processed service, the processor 220 may determine the predetermined tolerance based on a highest value of the first memory usage during the processing of the previously called service. For example, the processor 220 may determine the highest value of the first memory usage for the previously processed service as the predetermined tolerance. Further, as another example, the processor 220 may determine the predetermined tolerance by adding a constant ratio to the highest value (e.g., 120% of the highest value, etc.) for stability. In this case, when the processing of the service is completed, the processor 220 may store at least a part (for example, information on the highest value of the first memory usage, etc.) of the information on the first memory usage stored in the memory basket outside the request context and when the same service is repeatedly performed, the information on the first memory usage externally stored may be used for determining the predetermined tolerance for the repeated service. The predetermined tolerance may be set differently depending on the type of service. In addition, the predetermined tolerance may be set in common regardless of the type of service. However, the predetermined tolerance is not limited thereto and may be determined by various methods.

According to an exemplary embodiment of the present disclosure, the processor 220 may terminate the service if the first memory usage exceeds the predetermined tolerance. In this case, the processor 220 may inform the service requester that the first memory usage exceeds the predetermined tolerance. Further, the processor 220 may change the predetermined tolerance by checking the capacity of the in-use memory 230 of the computing device 200. In this case, the processor 220 may check and return the capacity of the memory 230 in use unnecessarily for the increase of the predetermined tolerance. By terminating the service when the first memory usage exceeds the predetermined tolerance, the memory control method of the present disclosure may prevent the system from going down due to insufficient memory while the service is processed.

According to an exemplary embodiment of the present disclosure, the processor 220 may clear the memory basket when the service is terminated. For example, the processor 220 may clear the memory basket when processing of the service is completed. Alternatively, when the first memory usage exceeds the predetermined tolerance and the service is terminated, the processor 220 may clear the memory basket. Accordingly, the method for controlling the memory according to the present disclosure may prevent the memory basket from being unnecessarily resident on the memory 230 of the computing device 200 after the service is terminated.

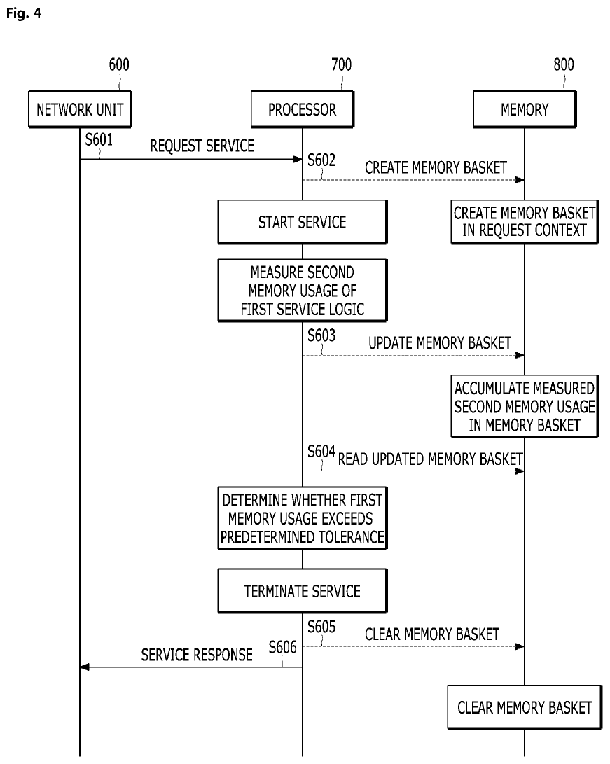

FIG. 4 is a flowchart for describing a method for controlling a memory on a service-oriented architecture according to an exemplary embodiment of the present disclosure.

The method for controlling the memory on the service-oriented architecture according to an exemplary embodiment of the present disclosure may be implemented on the computing device as follows. Referring to FIG. 4, the computing device may include a network unit 600, a processor 700, and a memory 800 like the computing device of FIG. 3. Of course, the computing device may include other components except for the components described above for performing the computing environment of the computing device.

The network unit 600 may receive the call of the service by the client from the external computing device. In this case, the network unit 600 may transfer to the received call of the service to the processor (s601). The processor 700 may generate a memory basket for measuring a first memory usage of the service as receiving the call of the service (s602). In this case, the processor 220 may create the memory basket in a request context on the memory 800. The processor 700 may process the service logic included in the service in order to process the service. When the processor 700 performs a first service logic among service logics included in the service, the processor 700 may measure the second memory usage to be used by the first service logic. Further, the processor 700 may update the memory basket based on the measured second memory usage (s603). In this case, the processor 700 may update the memory basket by accumulating the measured second memory usage in the memory basket. The processor 700 may read the updated memory basket (s604). The processor 700 may determine whether the first memory usage exceeds a predetermined tolerance based on the updated memory basket. The processor 700 may terminate the service if the first memory usage exceeds the predetermined tolerance. Further, when the first memory usage does not exceed the predetermined tolerance, the processor 700 may continuously perform the service logic which is not processed. When the service logic included in the service is completely completed, the service may be terminated. The processor 700 may clear the memory basket when the service is terminated (s605). In this case, the memory basket may be cleared in the request context. The processor 700 may give a response according to the completed service (s606). The exemplary embodiment referred by FIG. 4 is just an example and does not limit another example.

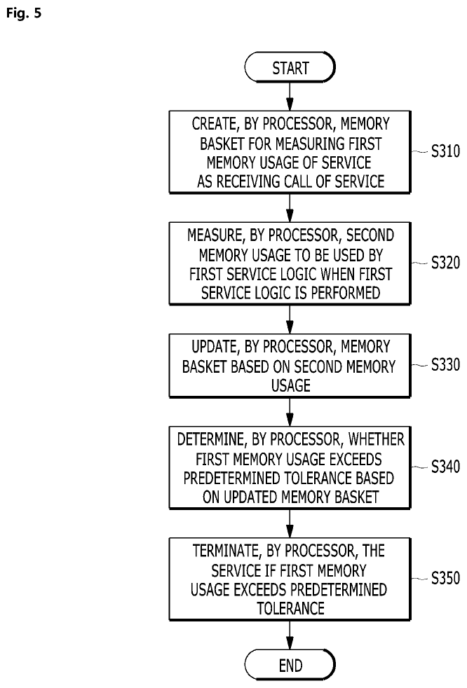

FIG. 5 is a flowchart for describing a method for controlling a memory on a service-oriented architecture according to an exemplary embodiment of the present disclosure.

The method for controlling the memory on the service-oriented architecture according to an exemplary embodiment of the present disclosure may be implemented by the following steps. The method may include: creating, by the processor, a memory basket for measuring a first memory usage of a service as receiving a call of the service (s310); measuring, by the processor, a second memory usage to be used by a first service logic when the first service logic is performed (s320); updating, by the processor, the memory basket based on the second memory usage (s330); and determining, by the processor, whether the first memory usage exceeds a predetermined tolerance based on the updated memory basket (s340).

In an alternative exemplary embodiment, the method may further include terminating, by the processor, the service if the first memory usage exceeds the predetermined tolerance (s350).

According to another exemplary embodiment of the present disclosure, the method for controlling the memory on the service-oriented architecture may be implemented by the following steps. The method may include: creating, by the framework, a memory basket for measuring a first memory usage of a service as receiving a call of the service (s310); measuring, by the framework, a second memory usage to be used by a first service logic when the first service logic is performed; updating, by the framework, the memory basket based on the second memory usage; and determining, by the framework, whether the first memory usage exceeds a predetermined tolerance based on the updated memory basket.

In an alternative exemplary embodiment, the method may further include terminating, by the framework, the service if the first memory usage exceeds the predetermined tolerance.

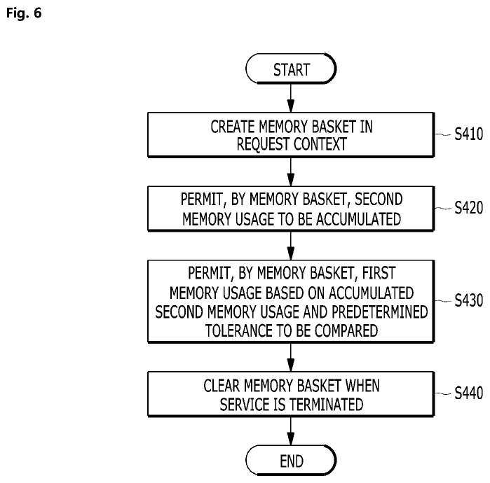

FIG. 6 is a flowchart for describing an operation related to a memory basket according to an exemplary embodiment of the present disclosure.

According to an exemplary embodiment of the present disclosure, the method for controlling the memory on the service-oriented architecture may include the following steps in relation with the operation for the memory basket. The method may include: creating a memory basket in a request context as a processor receives a call of the service; permitting, by the memory basket, accumulating the second memory usage; permitting, by the memory basket, comparing the first memory usage based on the accumulated second memory usage with the predetermined tolerance; and clearing the memory basket when the service is terminated.

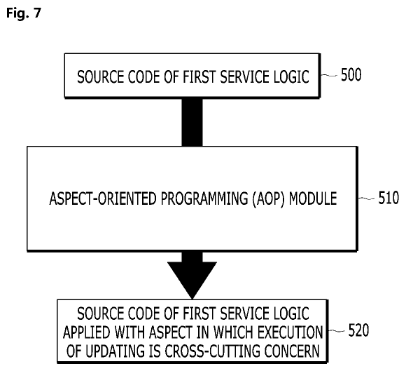

FIG. 7 is a diagram for describing an AOP module according to an exemplary embodiment of the present disclosure.

As described above, a first service logic may be a logic applied with an aspect in which execution of the updating step is a cross-cutting concern by using an aspect-oriented programming (AOP) module included in the processor. Specifically, on the service-oriented architecture, the updating step may be implemented by aspect-oriented programming (AOP) as the cross-cutting concern. The aspect-oriented programming may be a development paradigm that separates secondary or auxiliary functions from a business logic that directly implements the service or task which the application intends to provide. In the aspect-oriented programming, the business logic may be referred to as a primary concern and separate secondary or auxiliary functions may be referred to as the cross-cutting concern. For example, if the service is an account transfer from A to B, the primary concern of the service logic may mean an individual operation for the account transfer and the cross-cutting concern of the service logic may be logging, security, etc. which is an auxiliary function. The AOP module may enhance system scalability and compatibility of the system by implementing the secondary or auxiliary function that may be used in common for multiple business logics as the cross-cutting concern. The AOP module for the aspect-oriented programming may be implemented by AspectJ, AspectC/C++, SpringAOP, and the like depending on a system implementation language or environment, but is not limited thereto.

In an exemplary embodiment of the present disclosure, the execution of the updating step may be implemented as an independent module, called an aspect, as the cross-cutting concern and the processor may apply the aspect to the first service logic using the AOP module. In other words, a source code for implementing the updating step, which is the cross-cutting concern, may be coded on the source code of the first service logic, which is the primary concern. The updating step is implemented by the aspect-oriented programming (AOP), so that a code for an additional operation (that is, an operation of performing the update step) may be added while keeping the existing source code unmodified.

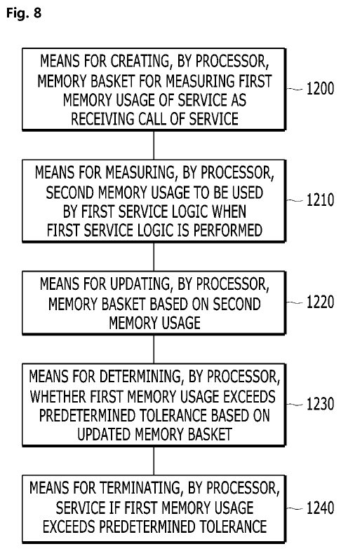

FIG. 8 is a diagram for describing a means for controlling a memory on a service-oriented architecture according to an exemplary embodiment of the present disclosure.

A technique for controlling the memory on the service-oriented architecture according to an exemplary embodiment of the present disclosure may be implemented by the following means. The means may include: a means 1200 for creating, by the processor, a memory basket for measuring a first memory usage of a service as receiving a call of the service; a means 1210 for measuring, by the processor, a second memory usage to be used by a first service logic when the first service logic is performed; a means 1220 for updating, by the processor, the memory basket based on the second memory usage; and a means 1230 for determining, by the processor, whether the first memory usage exceeds a predetermined tolerance based on the updated memory basket.

In an alternative exemplary embodiment, the means may further include a means 1240 for terminating, by the processor, the service if the first memory usage exceeds the predetermined tolerance.

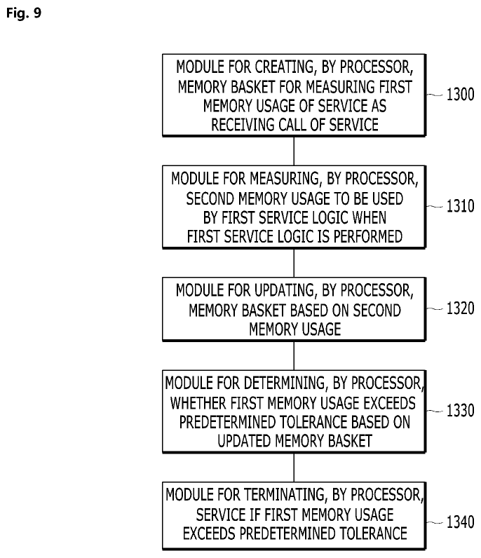

FIG. 9 is a diagram for describing a module for controlling a memory on a service-oriented architecture according to an exemplary embodiment of the present disclosure.

The technique for controlling the memory on the service-oriented architecture according to an exemplary embodiment of the present disclosure may be implemented by the following module. The module may include: a module 1300 for creating, by the processor, a memory basket for measuring a first memory usage of a service as receiving a call of the service; a module 1310 for measuring, by the processor, a second memory usage to be used by a first service logic when the first service logic is performed; a module 1320 for updating, by the processor, the memory basket based on the second memory usage; and a module 1330 for determining, by the processor, whether the first memory usage exceeds a predetermined tolerance based on the updated memory basket.

In an alternative exemplary embodiment, the module may further include a module 1340 for terminating, by the processor, the service by the processor if the first memory usage exceeds the predetermined tolerance.

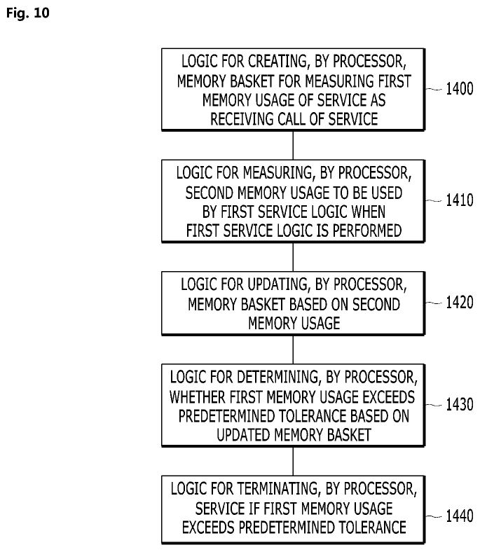

FIG. 10 is a diagram for describing a logic for controlling a memory on a service-oriented architecture according to an exemplary embodiment of the present disclosure.

The technique for controlling the memory on the service-oriented architecture according to an exemplary embodiment of the present disclosure may be implemented by the following logic. The logic may include: a logic 1400 for creating, by the processor, a memory basket for measuring a first memory usage of a service as receiving a call of the service; a logic 1410 for measuring, by the processor, a second memory usage to be used by a first service logic when the first service logic is performed; a logic 1420 for updating, by the processor, the memory basket based on the second memory usage; and a logic 1430 for determining, by the processor, whether the first memory usage exceeds a predetermined tolerance based on the updated memory basket.

In an alternative exemplary embodiment, the logic may further include a logic 1440 for terminating, by the processor, the service if the first memory usage exceeds the predetermined tolerance.

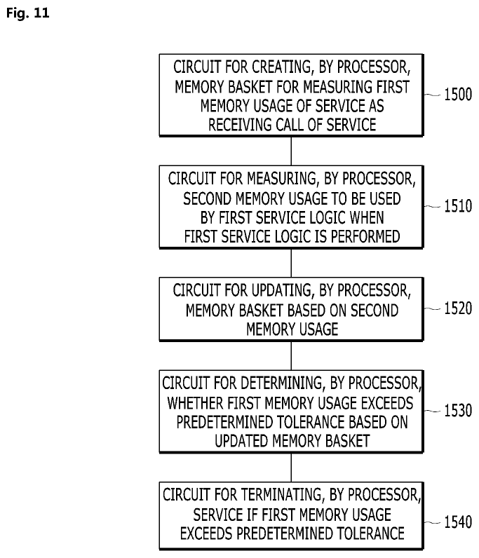

FIG. 11 is a diagram for describing a circuit for controlling a memory on a service-oriented architecture according to an exemplary embodiment of the present disclosure.

The technique for controlling the memory on the service-oriented architecture according to an exemplary embodiment of the present disclosure may be implemented by the following circuit. The circuit may include: a circuit 1500 for creating, by the processor, a memory basket for measuring a first memory usage of a service as receiving a call of the service; a circuit 1510 for measuring, by the processor, a second memory usage to be used by a first service logic when the first service logic is performed; a circuit 1420 for updating, by the processor, the memory basket based on the second memory usage; and a circuit 1530 for determining, by the processor, whether the first memory usage exceeds a predetermined tolerance based on the updated memory basket.

In an alternative exemplary embodiment, the circuit may further include a circuit 1540 for terminating, by the processor, the service if the first memory usage exceeds the predetermined tolerance.

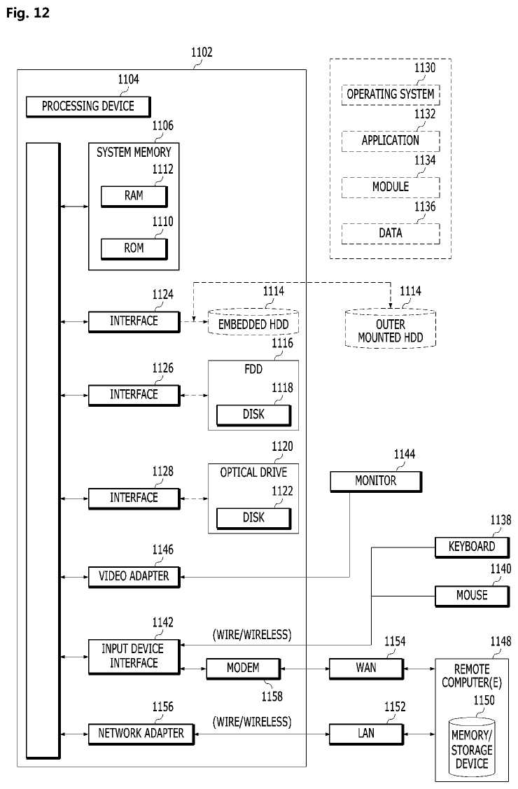

FIG. 12 illustrates a simple and general schematic view of an exemplary computing environment in which the exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof. The computer readable media include volatile and non-volatile media, transitory and non-transitory media, and mobile and non-mobile media. As not a limit but an example, the computer readable media may include both computer readable storage media and computer readable transmission media. The computer readable storage media include volatile and non-volatile media, temporary or non-temporary media, and movable and non-movable media implemented by a predetermined method or technology for storing information such as a computer readable command, a data structure, a program module, or other data. The computer storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor or other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated)-, a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable command, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input commands and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computer device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer-readable device. For example, a computer-readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein, but should be analyzed within the widest range which is consistent with the principles and new features presented herein.

What is claimed is:

1. A computer program stored in a computer-readable storage medium, wherein the computer program executes the following methods for processing information when the computer program is executed by one or more processors of a computing device, the method comprising:
creating, by the processor, a memory basket for measuring a first memory usage of a service as receiving a call of the service;
measuring, by the processor, a second memory usage to be used by a first service logic when the first service logic is performed;
updating, by the processor, the memory basket based on the second memory usage; and
determining, by the processor, whether the first memory usage exceeds a predetermined tolerance based on the updated memory basket.

2. The computer program of claim 1, wherein the method further includes terminating, by the processor, the service if the first memory usage exceeds the predetermined tolerance.

3. The computer program of claim 1, wherein the method further includes creating the memory basket in a request context allocated to the service.

4. The computer program of claim 1, wherein the updating includes accumulating the measured second memory usage in the memory basket.

5. The computer program of claim 1, wherein the first service logic is a logic applied with an aspect in which execution of the updating step is a cross-cutting concern by using an aspect-oriented programming (AOP) module included in the processor.

6. The computer program of claim 5, wherein a time point when the aspect is applied is a time point when a source code of the first service logic is complied.

7. The computer program of claim 6, wherein the time point when the aspect is applied is a time point when the source code of the first service logic is executed.

8. The computer program of claim 1, wherein the first service logic is a logic that sets data to a data object.

9. The computer program of claim 1, wherein the method further includes clearing, by the processor, the memory basket when the service is terminated.

10. A method for controlling a memory on a service-oriented architecture (SOA) performed by one or more processors, the method comprising:
creating, by the processor, a memory basket for measuring a first memory usage of a service as receiving a call of the service;
measuring, by the processor, a second memory usage to be used by a first service logic when the first service logic is performed;
updating, by the processor, the memory basket based on the second memory usage; and
determining, by the processor, whether the first memory usage exceeds a predetermined tolerance based on the updated memory basket.

11. A computing device comprising:
one or more processors; and
a memory storing commands executable in the one or more processors,
wherein the one or more processors
create a memory basket with respect to a call of a service,
measure a memory usage by a first service logic when the first service logic is performed,
update the memory basket based on the measured memory usage, and
determine whether a predetermined memory tolerance for the service is exceeded based on the memory basket.
